(19) United States
(12) Patent Application Publication
(10) Pub. No.: US 2026/0042916 A1
(43) Pub. Date: Feb. 12, 2026

(54) LOW-DENSITY ANTI-CORROSION PRIMER WITH STRONG ADHESION TO HEAVY FLASH RUST SURFACE AND PREPARATION METHOD THEREOF

(71) Applicant: MARINE CHEMICAL RESEARCH INSTITUTE CO., LTD., Qingdao City (CN)

(72) Inventors: LIANFENG WU, Qingdao City (CN); CHUNYING XU, Qingdao City (CN); MINHUA YI, Qingdao City (CN)

(21) Appl. No.: 19/359,668

(22) Filed: Oct. 15, 2025

(30) Foreign Application Priority Data
Mar. 27, 2025 (CN) 202510370744.0

(51) Int. Cl. C09D 5/08; C08G 59/24; C08G 59/44; C08K 3/04; C08K 3/08; C08K 3/22; C08K 3/30; C08K 3/34; C08K 5/17; C08K 7/28; C08K 9/06; C09D 5/00; C09D 7/20; C09D 7/40; C09D 7/45; C09D 7/62; C09D 7/80; C09D 163/00

(52) U.S. Cl. CPC C09D 5/084; C08G 59/245; C08G 59/44; C08K 3/04; C08K 3/34; C08K 5/17; C08K 7/28; C08K 9/06; C09D 5/002; C09D 7/20; C09D 7/45; C09D 7/62; C09D 7/70; C09D 7/80; C09D 163/00; C08K 2003/0812; C08K 2003/2241; C08K 2003/3045

(57) ABSTRACT

The present disclosure discloses a low-density anti-corrosion primer with strong adhesion to heavy flash rust surface and its preparation method, which relates to the field of paint chemical industry. The epoxy primer includes component A and component B; the component A includes epoxy resin, double-layer coated hollow glass microspheres, thixotropic agent, wetting dispersant, pigment, barium sulfate, talcum powder, solvent A, defoamer, first silane coupling agent, and aluminum powder slurry; the B component includes curing agent, promoter, and solvent B. The low-density epoxy primer of the present disclosure, which strongly adheres to heavy flash rust surface, has excellent adhesion and anti-corrosion performance on metal substrate surfaces treated by manual rust removal, mechanical rust removal, water sandblasting rust removal, and other methods. It has a high tolerance for the flash rust on the surface treated by water sandblasting rust removal and can be adapted to heavy flash rust surfaces.

### CROSS-REFERENCE TO RELATED APPLICATIONS

This application claims priority to a Chinese Application No. 202510370744.0, filed on Mar. 27, 2025, the entire contents of which are hereby incorporated herein by reference in their entirety.

### TECHNICAL FIELD

The present disclosure relates to the technical field of paint chemical industry, in particular to a low-density anti-corrosion primer with strong adhesion to heavy flash rust surface and preparation method thereof.

### BACKGROUND

Steel components, as a type of metal material, are widely used in various fields such as construction, manufacturing, and transportation. They are also the core material of modern shipbuilding industry, mainly used for the manufacturing of ship structures, equipment, and components. Before leaving the factory, steel components are usually coated with workshop primer or clear varnish, and the protection period for workshop primer or clear varnish is about 3-6 months. However, the construction period of steel components is long and the internal corrosion is severe, so it is necessary to remove rust from the steel structure.

Among various rust removal methods, high-pressure water sandblasting is dust-free throughout the entire process and has low cost. Therefore, due to its economic, efficient, and environmentally friendly characteristics, it has gradually become the mainstream choice in the field of rust removal, and is particularly widely used in large cruise ships and cargo ships. After rust removal through high-pressure water sandblasting, the surface of steel components exposed to air may occur varying degrees of flash rust due to moisture or corrosive substances. Flash rust includes light flash rust (L), moderate flash rust (M), and heavy flash rust (H), with H-grade being the most severe flash rust level. heavy flash rust has a severe degree of corrosion, appearing as a dark red yellow or brown rust layer on the surface of the original steel, and the rust layer is thick and loosely attached, evenly distributed and presented in patches. After gently wiping with a cloth, obvious rust stains appear on the cloth. Heavy flash rust seriously affects the adhesion of coatings, causing coating peeling or bubbling, weakening the anti-corrosion ability of metals, shortening their service life, and affecting surface aesthetics, reducing product value.

Chinese patent application CN109370380A discloses a high solid rust anti-corrosion coating and its preparation method, mainly focusing on environmentally friendly coatings that do not cause pollution to the environment. Chinese patent application CN103788829A discloses a heavy-duty anti-corrosion epoxy primer for low-grade substrate, which can be applied to low-grade substrate treated steel with rust and moisture. Chinese patent application CN103725159A discloses a highly adaptable anti-corrosion coating, which has good adhesion and excellent anti-corrosion, weather resistance, and medium resistance properties with hot-dip galvanizing, rusted hot-dip galvanizing, corroded steel, and conventional old coatings using epoxy, acrylic, and fluorocarbon resins as film-forming materials. Chinese patent application CN113321987A discloses a high tolerance epoxy primer for water jet surface rust removal and its preparation method and application. The primer is suitable for the moderate or light flash rust surface of steel structures with residual corrosion inhibitor on the surface after water jet rust removal treatment. The coatings involved in the above have their own advantages, but none of them are suitable for heavy flash rust surfaces.

There is no report on the formation about flash rust with H-grade generated on the surface of high-pressure water sandblasting. The salt spray resistance of epoxy primer with low surface treatment has only reached 1000-1400 hours, which is still far from the high salt spray resistance requirement of over 5000 hours required for heavy anti-corrosion applications in ships and marine engineering.

### SUMMARY

In order to solve the problems existing in the existing technology, the present disclosure provides a low-density epoxy primer with strong adhesion to the surface of heavy flash rust and its preparation method. The low-density anti-corrosion primer with strong adhesion to heavy flash rust surface of the present disclosure has excellent adhesion and anti-corrosion performance on metal substrate surfaces treated by manual rust removal, mechanical rust removal, water sandblasting rust removal, etc. It has high tolerance for flash rust on water sandblasting rust removal surfaces and can be adapted to heavy flash rust surfaces.

The first objective of the present disclosure is to provide a low-density anti-corrosion primer with strong adhesion to heavy flash rust surface.

The low-density anti-corrosion primer with strong adhesion to heavy flash rust surface described in the present disclosure is made from raw materials including the following components:
A component A and a component B;
The component A includes epoxy resin, double-layer coated hollow glass microspheres, thixotropic agent, wetting dispersant, pigment, barium sulfate, talcum powder, solvent A, defoamer, first silane coupling agent, and aluminum powder slurry;
The component B includes curing agent, accelerator, and solvent B;
In the component A, based on 100 parts by weight of the epoxy resin:

| | | |
|---|---|---|
| The epoxy resin | 100 | parts by weight; |
| The double-layer coated hollow | 100-300 | parts by weight; |
| glass microspheres | | |
| The thixotropic agent | 5-15 | parts by weight; |
| The wetting dispersant | 0.5-5 | parts by weight; |
| The pigment | 1-10 | parts by weight; |
| The barium sulfate | 60-200 | parts by weight; |
| The talcum powder | 60-200 | parts by weight; |
| The solvent A | 60-150 | parts by weight; |
| The defoamer | 1-5 | parts by weight; |
| The first silane coupling agent | 1-10 | parts by weight; |
| The aluminum powder slurry | 40-100 | parts by weight; |

In the component B, based on 100 parts
by weight of the curing agent:

| | | |
|---|---|---|
| The curing agent | 100 | parts by weight; |
| The accelerator | 0.5-5 | parts by weight; |
| The solvent B | 10-50 | parts by weight. |

In a preferred embodiment of the present disclosure:

In the component A, based on 100 parts by weight of the epoxy resin:

| | | |
|---|---|---|
| The epoxy resin | 100 | parts by weight; |
| The double-layer coated hollow | 150-250 | parts by weight; |
| glass microspheres | | |
| The thixotropic agent | 5-13 | parts by weight; |
| The wetting dispersant | 1.8-3 | parts by weight; |
| The pigment | 3-10 | parts by weight; |
| The barium sulfate | 90-120 | parts by weight; |
| The talcum powder | 120-150 | parts by weight; |
| The solvent A | 100-150 | parts by weight; |
| The defoamer | 2-4 | parts by weight; |
| The first silane coupling agent | 3-6 | parts by weight; |
| The aluminum powder slurry | 40-80 | parts by weight. |

In the component B, based on 100 parts
by weight of the curing agent:

| | | |
|---|---|---|
| curing agent | 100 | parts by weight; |
| accelerator | 0.5-2 | parts by weight; |
| solvent B | 30 | parts by weight. |

The weight ratio of the component A to the component B is 100: (10-50), preferably 100: (12-45).

In a preferred embodiment of the present disclosure:

The double-layer coated hollow glass microspheres are prepared by mixing and reacting raw materials including epoxy resin to be modified, rust capturing filler, isocyanate prepolymer, catalyst, and reaction solvent in a protective gas atmosphere.

In a preferred embodiment of the present disclosure:
The weight ratio of the epoxy resin to be modified, the rust capturing filler, and the isocyanate prepolymer is (5-15): (1-5): 1, preferably (8-12): (1.5-3.8): 1;
The dosage of the catalyst is 0.01 wt % to 5 wt % of isocyanate prepolymer, preferably 0.1 wt % to 1 wt % of isocyanate prepolymer;
The dosage of the reaction solvent used is 20-40 wt % of the epoxy resin to be modified, preferably 25-30 wt % of the epoxy resin to be modified;
The reaction temperature for mixed reaction is a range of 80° C. to 100° C., with a preferred range of 80° C. to 90° C., and the reaction time is a range of 1 to 5 hours, with a preferred range of 2 to 3 hours.

In a preferred embodiment of the present disclosure:
The rust capturing filler is prepared by immersing hollow glass microspheres in a solution containing tannic acid, a second silane coupling agent, and a soaking solvent, followed by low-temperature freeze-drying;
The isocyanate prepolymer is prepared by vacuum dehydration of dimer acid polyester polyol, followed by cooling, and then performing pre-polymerization reaction with isocyanate in a protective gas atmosphere;
The epoxy resin to be modified is at least one type of bisphenol A epoxy resins, preferably at least one of bisphenol A epoxy resin 618, bisphenol A epoxy resin 6101, bisphenol A epoxy resin 601, or bisphenol A epoxy resin 604; preferably, the epoxy equivalent of the epoxy resin to be modified is 150-1000;
The catalyst is at least one selected from the group consisting of sulfuric acid, perchloric acid, sodium methoxide, lithium methoxide, potassium eicosyl sulfonate, alkali metal hydroxide, triarylphosphine, triphenylphosphine, stannous octoate, dibutyltin dilaurate, and iron bromide;
The reaction solvent is a mixture of xylene and at least one of butyl acetate, propylene glycol methyl ether acetate, and dipropylene glycol dimethyl ether, preferably, the weight ratio of the mixture of the xylene and at least one of the butyl acetate, the propylene glycol methyl ether acetate, and the dipropylene glycol dimethyl ether is (1.5-1): 1.

In a preferred embodiment of the present disclosure:
The weight ratio of the soaking solvent, the tannic acid, the second silane coupling agent, and the hollow glass microspheres is (0.4-2):(0.1-0.5):(0.1-0.5):1, preferably (0.8-1.6):(0.2-0.4):(0.25-0.4):1;
The weight ratio of isocyanate to dimer acid polyester polyol is 1:(0.5-10), preferably 1:(0.9-6).

In a preferred embodiment of the present disclosure:
The standard median particle size of the hollow glass microspheres is 18-60 μm, preferably 30-50 μm;
The tannic acid is a commonly used tannic acid in this field, which can be chemically pure or analytically pure;
The second silane coupling agent is at least one selected from the group consisting of vinyltrimethoxysilane, γ-glycidoxypropyltrimethoxysilane (such as silane coupling agent KH560, silane coupling agent A187), and γ-aminopropyltriethoxysilane (such as silane coupling agent KH550);
The soaking solvent is a mixture of water and ethanol, preferably with a weight ratio of (0.5-2): 1, and more preferably (0.6-1.5): 1;
The isocyanate is at least one selected from the group consisting of 2,6-toluene diisocyanate, 4,4′-diphenylmethane diisocyanate, carbodiimide-uretonimine modified 4,4′-diphenylmethane diisocyanate, 2,4′-diphenylmethane diisocyanate, and polymethylene polyphenyl polyisocyanate;
The molecular weight of the dimer acid polyester polyol is between 1000 and 10000.

In a preferred embodiment of the present disclosure:
The soaking temperature is 10-50° C., preferably 20-40° C., and the soaking time is 1-4 hours, preferably 2-3 hours;
The temperature of the low-temperature freeze-drying is −30° C. to ˜90° C., preferably −40° C. to −80° C., and the time of the low-temperature freeze-drying is 1-5 hours, preferably 2-4 hours;
The temperature of the vacuum dehydration is 110-150° C., the vacuum degree is −0.08 Pa to −0.10 Pa, and the time of the vacuum dehydration is 0.5 h-2 h;
The temperature after cooling is below 60° C.;
The reaction temperature of the pre-polymerization reaction is between 80° C. and 100° C., with a preferred range of 80° C. to 90° C., and the reaction time of the pre-polymerization reaction is between 1 and 4 hours, with a preferred range of 2 to 3 hours.

In a preferred embodiment of the present disclosure:
The epoxy resin is at least one type of liquid bisphenol A epoxy resin, preferred is at least one of bisphenol A epoxy resin 618, bisphenol A epoxy resin 6101, bisphenol A epoxy resin 601, bisphenol A epoxy resin 604, or bisphenol A epoxy resin 618;
The thixotropic agent is at least one selected from the group consisting of organic bentonite, modified hydrogenated castor oil, polyamide wax powder (such as polyamide wax powder ultra, polyamide wax powder 8056, polyamide wax powder OPTIMA), and gas-phase silica; preferably, the polyamide wax powder is hydrogenated castor oil modified polyamide wax powder (such as castor oil modified polyamide wax powder ST);
The wetting dispersant is at least one selected from the group consisting of polyacrylate solution (wetting dispersant BYK-S706), block copolymer containing basic pigment-affinity groups (wetting dispersant BYK-2155), alkylammonium salt type wetting dispersant of high molecular weight copolymer (wetting dispersant BYK-9076), acrylic dispersing agent (wetting dispersant BYK-359), organic silicon surfactant, copolymer solution with acid groups (wetting dispersan Disponer 9250), and polycarboxylic acid alkylammonium salt solution (wetting dispersan BYK-203);
The pigment is at least one selected from the group consisting of carbon black, iron oxide red, iron oxide yellow, titanium dioxide, and phthalocyanine blue;
The solvent A is n-butanol and optionally xylene;
The defoamer is a commonly used defoamer in this field, such as at least one of defoamer BYK-530, defoamer BYK-085, and defoamer BYK-066;
The first silane coupling agent is at least one selected from the group consisting of vinyltrimethoxysilane, γ-glycidoxypropyltrimethoxysilane (silane coupling agent KH560, silane coupling agent A187), and γ-aminopropyltriethoxysilane (silane coupling agent KH550);
The aluminum powder slurry is a non floating aluminum powder slurry (non floating aluminum powder slurry 2501);
The curing agent is at least one type of phenolic amide curing agent (phenolic amide curing agent LITE3040, phenolic amide curing agent LITE3025, phenolic amide curing agent LITE3060), preferably cardanol modified phenolic amide curing agent; cardanol in cardanol modified phenolic amide curing agent has a longer fatty side chain and better hydrophobicity, which can make the coating exhibit excellent water resistance and surface resistance. At the same time, it combines the advantages of polyamide and phenolic amine, and has a high tolerance for the substrate surface;
The accelerator is an epoxy curing accelerator, preferably at least one selected from the group consisting of triethylenediamine, 2,4,6-tris (dimethylaminomethyl) phenol (accelerator DMP-30), and benzyldimethylamine, and more preferably 2,4,6-tris (dimethylaminomethyl) phenol
The solvent B is n-butanol and optionally xylene, preferably a mixture of n-butanol and xylene, and more preferably, the weight ratio of n-butanol to xylene is (0.3-1.5): 1.

The second objective of the present disclosure is to provide a method for preparing a low-density anti-corrosion primer with strong adhesion to heavy flash rust surface as described in the first objective of the present disclosure.

The low-density anti-corrosion primer with strong adhesion to heavy flash rust surface according to the present disclosure, including:

Preparing the component A according to the specified dosage of the component A, preparing the component B according to the specified dosage of the component B, then mixing the component A and the component B to prepare the epoxy primer.

The preparation method of component A can be specifically adopted as follows:

### (1) Preparation of Double-Layer Coated Hollow Glass Microspheres:

Step 1: Preparation of rust capturing filler (surface modification of hollow glass microspheres): Taking the second silane coupling agent and tannic acid to perform surface modification on hollow glass microspheres, then soaking the hollow glass microspheres in the solution containing the second silane coupling agent, tannic acid, and soaking solvent at 10-50° C. for 1-4 hours, then freezing dry to remove water and ethanol to obtain the rust capturing filler;
Step 2: Synthesis of isocyanate prepolymer: performing vacuum dehydration on the dimer acid polyester polyol at 110-150° C., then adding the dehydrated dimer acid polyester polyol and isocyanate to a reaction vessel under a protective gas atmosphere (nitrogen), maintaining the reaction temperature at 80-100° C. for 1-4 hours, then measuring the content of isocyanate, and then discharging the synthesized isocyanate prepolymer;
Step 3: Taking another reaction vessel, performing vacuum dehydration on the epoxy resin to be modified, adding a catalyst while stirring, then gradually adding the synthesized isocyanate prepolymer, gradually heating up to 80-100° C. for reaction, then adding the synthesized rust capturing filler, adding the reaction solvent and stirring evenly, heating up to 80-100° C. for reaction, then measuring the epoxy value, cooling down to room temperature, and discharging the epoxy resin;
(2) Selecting a paint mixing tank, then adding epoxy resin, double-layer coated hollow glass microspheres, and thixotropic agent, then dispersing at high speed for 5-10 minutes to thoroughly disperse the thixotropic agent, and then adding wetting dispersant at low speed and stirring evenly;
(3) Adding 80% solvent A, pigment, talcum powder, and barium sulfate in sequence under low-speed dispersion, then stirring at high speed for 30-50 minutes to 50-70° C., dispersing to a fineness of <80 μm, then adding the remaining solvent A, defoamer, first silane coupling agent, and aluminum powder slurry, stirring evenly, and then discharging the epoxy primer.

Compared with the existing technology, the advantageous effects of the present disclosure are:

1. The double-layer coated hollow glass microspheres used in the present disclosure introduce isocyanate prepolymers and rust capturing fillers (modified hollow glass microspheres) into the epoxy resin molecules to be modified, improving the compatibility between the hollow glass microspheres and the epoxy resin to be modified, and enabling the rust capturing fillers (modified hollow glass microspheres) to be uniformly dispersed in the paint solution. As shown in FIG. 1 to FIG. 3, during the initial stage of painting, i.e. before curing, the tannic acid on the surface of hollow glass microspheres can adsorb and react with the rust on the substrate surface when the paint film comes into contact with the low treatment surface; \textcircled{2} During curing, hollow glass microspheres utilize their low specific gravity to adsorb reactants and gradually detach from the substrate surface, floating up to the middle or upper layer of the paint solution; \textcircled{3} After curing, the rust adsorbed by hollow glass microspheres can be used as a filler to fill epoxy resin paint, without affecting the adhesion of the paint film to the substrate, ensuring high adhesion. The epoxy primer of the present disclosure not only improves the adhesion of heavy flash rust surface, but also utilizes the low specific gravity of hollow glass microspheres to achieve the requirement of lightweight coating.

2. The isocyanate prepolymers pre-polymerized from isocyanate and dimer acid polyester polyol used in the present disclosure increase the molecular cross-linking degree and toughness of the system, improve the reactivity, impact resistance, adhesion, and peel strength of the epoxy resin, and enhance the adhesion to the substrate surface.

3. The low-density epoxy primer provided by the present disclosure for strong adhesion to heavy flash rust surfaces can solve the technical problems that cannot be simultaneously used for mechanical rust removal, manual rust removal, water sandblasting rust removal, etc. in the existing technology. Under different levels of flash rust on the surface after water sandblasting treatment, especially on heavy (H) flash rust surfaces, the epoxy primer has high adhesion and excellent salt spray resistance, which is suitable for anti-corrosion coating in fields such as ships, bridges, and steel structures, especially for direct construction on flash rust surfaces, simplifying surface treatment processes and improving construction efficiency and economy.

### BRIEF DESCRIPTION OF THE DRAWINGS

FIG. 1 is a schematic diagram of the curing process of the low-density epoxy primer with strong adhesion to the heavy flash rust surface of the present disclosure;

FIG. 2 is a microscopic schematic diagram of the curing process of the low-density epoxy primer with strong adhesion to the heavy flash rust surface of the present disclosure before curing;

FIG. 3 is a microscopic schematic diagram of the curing process of the low-density epoxy primer with strong adhesion to the heavy flash rust surface of the present disclosure during curing.

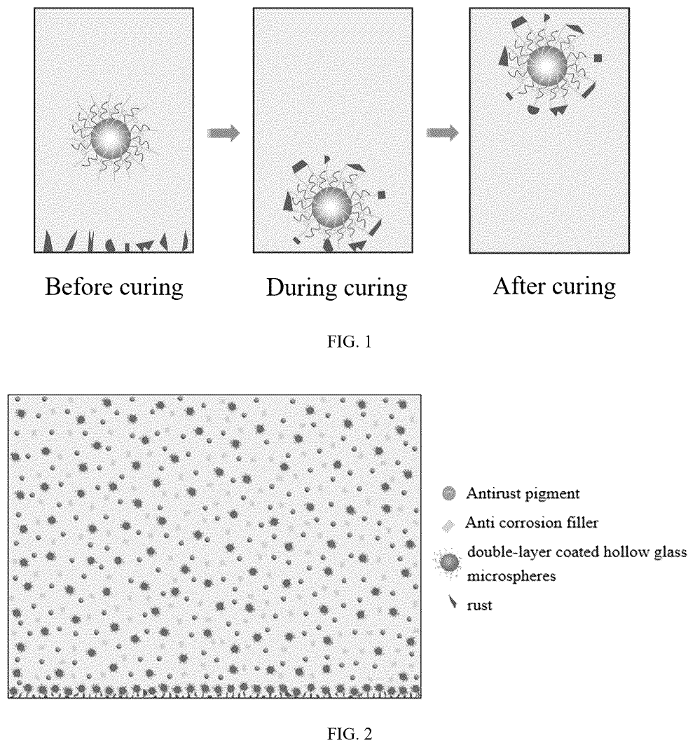

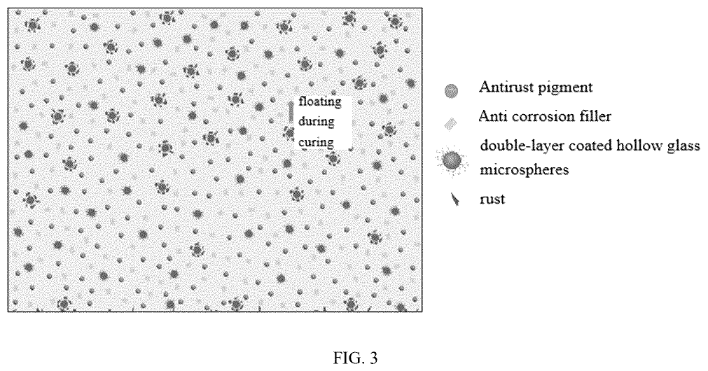

### DETAILED DESCRIPTION OF THE EMBODIMENTS

The present disclosure will be described in detail below with reference to specific drawings and embodiments. It is necessary to point out that the following embodiments are only used for further illustration of the present disclosure and cannot be understood as limitations to the scope of the present disclosure. Some non essential improvements and adjustments made by those skilled in the art based on the content of the present disclosure still fall within the scope of the present disclosure.

The raw materials used in the embodiments and comparative examples of the present disclosure are conventional commercially available materials.

The testing methods used in the embodiments and comparative examples of the present disclosure are as follows:
Density: tested according to GB/T 6750;
Salt spray resistance (5000 h): tested according to GB/T1771;
Cathodic stripping resistance (6 months, distance from artificial opening in stripping area): tested according to GB/T7790 standard;
Adhesion: tested according to GB/T 5210 standard.

### Embodiment 1

Preparation of component A:

### (1) Preparation of Double-Layer Coated Hollow Glass Microspheres:

Step 1: Preparation of rust capturing filler (surface modification of hollow glass microspheres): Taking 20 parts by weight of tannic acid and 25 parts by weight of silane coupling agent KH560 to add them to 80 parts by weight of a mixed solution of water and ethanol in a weight ratio of 1:1, stirring evenly; then adding 100 parts by weight of hollow glass microspheres with a standard median particle size of 30 μm and the mixed liquid to a powder mixer, mixing thoroughly and evenly, then soaking at 20° C. for 3 hours, then freezing dry to remove water and ethanol to obtain the rust capturing filler (modified hollow glass microspheres);
Step 2: Synthesis of isocyanate prepolymer: Taking 288 parts by weight of dimer acid polyester polyol (functionality 2, molecular weight 1000) to perform vacuum dehydration at 120° C. for 2 hours, then cooling to 60° C., adding 100 parts by weight of 2,6-toluene diisocyanate while stirring, stirring thoroughly, gradually raising the temperature to 80° C., holding the temperature for 2 hours, then measuring the content of isocyanate, and the resulting product is isocyanate prepolymer;
Step 3: Taking another reaction vessel, taking 8 parts by weight of bisphenol A epoxy resin 601, 1 part by weight of xylene, and 1 part by weight of dipropylene glycol dimethyl ether, heating to 60° C. and stirring for half an hour, after fully dissolution, adding 1 part by weight of isocyanate prepolymer, stirring for 15 minutes, and stirring thoroughly and evenly; adding stannous octoate of 1 wt % isocyanate prepolymer under stirring, gradually raising the temperature to 90° C., and holding the temperature for 2.5 hours; adding 1.5 parts by weight of rust capturing filler (modified hollow glass microspheres) under stirring, maintaining at 90° C. for 1 hour, and measuring the epoxy value. The resulting product is double-layer coated hollow glass microspheres.

(2) The Component A was prepared by high-speed dispersion of bisphenol A epoxy resin 618, double-layer coated hollow glass microspheres, barium sulfate, talcum powder, carbon black, titanium dioxide, polyamide wax powder ultra, wetting dispersant BYK-359, defoamer BYK-530, silane coupling agent KH560, xylene, n-butanol, and non floating aluminum powder slurry 2501 according to the ratio in Table 1.

Preparation of component B:

Adding the phenolic amide curing agent LITE3040, accelerator DMP-30, xylene, and n-butanol to the paint tank according to the ratio in Table 1, and stirring at high speed for 30 minutes using a high-speed shearing and dispersing device to obtain component B.

The weight ratio of the component A to the component B is 100:14.

TABLE 1

| | parts by weight |
|---|---|
| Component A | |
| Epoxy resin WSR618 | 100 |
| double-layer coated hollow | 207.9 |
| glass | |
| microspheres | |
| barium sulfate | 110 |
| talcum powder | 140 |
| Titanium Dioxide | 2.7 |
| carbon black | 0.31 |
| Non-floating aluminum powder | 40 |
| paste 2501 | |
| Polyamide Wax powder Ultra | 6.8 |
| Silane Coupling Agent KH560 | 4.2 |
| wetting dispersant BYK-359 | 3 |
| Defoamer BYK530 | 3.96 |
| dimethylbenzene | 84.6 |
| n-butanol | 16.4 |
| Component B | |
| phenolic amide curing agent | 100 |
| LITE3040 | |
| Accelerator DMP-30 | 2 |
| dimethylbenzene | 5 |
| n-butanol | 5 |

### Embodiment 2

### Preparation of Component A:

### (1) Preparation of Double-Layer Coated Hollow Glass Microspheres:

Step 1: Preparation of rust capturing filler (surface modification of hollow glass microspheres): Taking 20 parts by weight of tannic acid and 20 parts by weight of silane coupling agent KH560 to add them to 100 parts by weight of a mixed solution of water and ethanol in a weight ratio of 1:1, stirring evenly; then adding 100 parts by weight of hollow glass microspheres with a standard median particle size of 50 μm and the mixed liquid to a powder mixer, mixing thoroughly and evenly, then soaking at 40° C. for 3 hours, then freezing dry to remove water and ethanol to obtain the rust capturing filler (modified hollow glass microspheres);
Step 2: Synthesis of isocyanate prepolymer: Taking 600 parts by weight of dimer acid polyester polyol (functionality 2, molecular weight 2000) to perform vacuum dehydration at 120° C. for 2 hours, then cooling to 60° C., adding 100 parts by weight of 2,6-toluene diisocyanate while stirring, stirring thoroughly, gradually raising the temperature to 80° C., holding the temperature for 2 hours, then measuring the content of isocyanate, and the resulting product is isocyanate prepolymer;
Step 3: Taking another reaction vessel, taking 8 parts by weight of bisphenol A epoxy resin 6101, 1 part by weight of xylene, and 1 part by weight of dipropylene glycol dimethyl ether, adding 1 part by weight of isocyanate prepolymer, stirring for 15 μminutes, and stirring thoroughly and evenly; adding dibutyltin dilaurate of 1 wt % isocyanate prepolymer under stirring, gradually raising the temperature to 90° C., and holding the temperature for 2.5 hours; adding 1.5 parts by weight of rust capturing filler (modified hollow glass microspheres) under stirring, maintaining at 90° C. for 1 hour, and measuring the epoxy value. The resulting product is double-layer coated hollow glass microspheres.
(2) The component A was prepared by high-speed dispersion of bisphenol A epoxy resin 618, double-layer coated hollow glass microspheres, barium sulfate, talcum powder, iron oxide red, polyamide wax powder ultra, wetting dispersant BYK-2155, defoamerflYK-530, silane coupling agent KH560, xylene, n-butanol, and non floating aluminum powder slurry 2501 according to the ratio in Table 2.
   Preparation of component B:

Adding the phenolic amide curing agent L5TE3040, accelerator DMP-30, xylene, and n-butanol to the paint tank according to the ratio in Table 2, and stirring at high speed for 30 minutes using a high-speed shearing and dispersing device to obtain component B.

The weight ratio of the component A to the component B is 100:16.

TABLE 2

| | parts by weight |
|---|---|
| Component A | |
| Epoxy resin WSR618 | 100 |
| double-layer coated hollow | 150 |
| glass | |
| microspheres | |
| barium sulfate | 90 |
| talcum powder | 125 |
| Iron oxide red | 3 |
| Non-floating aluminum powder | 43.8 |
| paste 2501 | |
| Polyamide Wax powder Ultra | 5 |
| Silane Coupling Agent KH560 | 6 |
| wetting dispersant BYK-2155 | 1.8 |
| Defoamer BYK530 | 2 |
| dimethylbenzene | 121.6 |
| n-butanol | 27.4 |
| component B | |
| phenolic amide curing agent | 100 |
| LITE3040 | |
| Accelerator DMP-30 | 2 |
| dimethylbenzene | 15 |
| n-butanol | 4.6 |

### Embodiment 3

### Preparation of Component A:

### (1) Preparation of Double-Layer Coated Hollow Glass Microspheres:

Step 1: Preparation of rust capturing filler (surface modification of hollow glass microspheres): Taking 40 parts by weight of tannic acid and 25 parts by weight of silane coupling agent KH560 to add them to 160 parts by weight of a mixed solution of water and ethanol in a weight ratio of 1:1, stirring evenly; then adding 100 parts by weight of hollow glass microspheres with a standard median particle size of 40 μm and the mixed liquid to a powder mixer, mixing thoroughly and evenly, then soaking at 40° C. for 2 hours, then freezing dry to remove water and ethanol to obtain the rust capturing filler (modified hollow glass microspheres);
Step 2: Synthesis of isocyanate prepolymer: Taking 90 parts by weight of dimer acid polyester polyol (functionality 2, molecular weight 2000) to perform vacuum dehydration at 120° C. for 2 hours, then cooling to 60° C., adding 100 parts by weight of 2,4′-diphenylmethane diisocyanate while stirring, stirring thoroughly, gradually raising the temperature to 80° C., holding the temperature for 2 hours, then measuring the content of isocyanate, and the resulting product is isocyanate prepolymer;
Step 3: Taking another reaction vessel, taking 12 parts by weight of bisphenol A epoxy resin 6101, 1.8 part by weight of xylene, and 1.2 part by weight of dipropylene glycol dimethyl ether, heating to 60° C. and stirring for half an hour, after fully dissolution, adding 1 part by weight of isocyanate prepolymer, and stirring thoroughly and evenly; adding dibutyltin dilaurate of 1 wt % isocyanate prepolymer under stirring, gradually raising the temperature to 90° C., and holding the temperature for 2.5 hours; adding 3.8 parts by weight of rust capturing filler (modified hollow glass microspheres) under stirring, maintaining at 90° C. for 1 hour, and measuring the epoxy value. The resulting product is double-layer coated hollow glass microspheres.

(2) The component A was prepared by high-speed dispersion of bisphenol A epoxy resin 6101, double-layer coated hollow glass microspheres, barium sulfate, Iron oxide red, polyamide wax powder 8056, wetting dispersant BYK-203, defoamer BYK-066, silane coupling agent KH560, xylene, n-butanol, and non floating aluminum powder slurry 2501 according to the ratio in Table 3.

### Preparation of Component B:

Adding the phenolic amide curing agent LiTE3025, accelerator DMP-30, xylene, and n-butanol to the paint tank according to the ratio in Table 3, and stirring at high speed for 30 minutes using a high-speed shearing and dispersing device to obtain component B.

The weight ratio of the component A to the component B is 100:19.

TABLE 3

| | parts by weight |
|---|---|
| Component A | |
| Bisphenol A epoxy resin 6101 | 100 |
| double-layer coated hollow | 250 |
| glass | |
| microspheres | |
| barium sulfate | 102.3 |
| talcum powder | 150 |
| Iron oxide red | 3 |
| Non-floating aluminum powder | 60 |
| paste 2501 | |
| Polyamide Wax powder 8056 | 6.7 |
| Silane Coupling Agent KH560 | 5.4 |
| wetting dispersant BYK-203 | 3.7 |
| Defoamer BYK-066 | 3.1 |
| dimethylbenzene | 73.8 |
| n-butanol | 10.6 |
| Component B | |
| phenolic amide curing agent | 100 |
| LITE3025 | |
| Accelerator DMP-30 | 0.8 |
| dimethylbenzene | 18 |
| n-butanol | 12 |

### Embodiment 4

### Preparation of Component A:

(1) The preparation of double-layer coated hollow glass microspheres is the same as Embodiment 1;
(2) Component A was prepared by high-speed dispersion of bisphenol A epoxy resin 6101, double-layer coated hollow glass microspheres, talcum powder, barium sulfate, titanium dioxide, carbon black, castor oil modified polyamide wax powder ST, wetting dispersan BYK-203, defoamer BYK-066, silane coupling agent KH560, xylene, n-butanol, and non floating aluminum powder slurry 2501 according to the ratio in Table 4.

### Preparation of Component B:

Adding the phenolic amide curing agent LITE3060, phenolic amide curing agent LITE3040, accelerator DMP-30, xylene, and n-butanol into the paint tank according to the ratio in Table 4, and stirring at high speed for 30 minutes using a high-speed shearing and dispersing device to obtain component B.

The weight ratio of the component A to the component B is 100:12.

TABLE 4

| | parts by weight |
|---|---|
| Component A | |
| Bisphenol A epoxy resin 6101 | 100 |
| double-layer coated hollow | 189 |
| glass | |
| microspheres | |
| barium sulfate | 110.4 |
| talcum powder | 120 |
| titanium dioxide | 9.8 |
| carbon black | 0.2 |
| Non-floating aluminum powder | 60 |
| paste 2501 | |
| castor oil modified polyamide | 13 |
| wax | |
| powder ST | |
| Silane Coupling Agent KH560 | 3 |
| wetting dispersant BYK-203 | 2.5 |
| Defoamer BYK-066 | 2.7 |
| dimethylbenzene | 93.6 |
| n-butanol | 23.9 |
| component B | |
| phenolic amide curing agent | 80 |
| LITE3060 | |
| phenolic amide curing agent | 20 |
| LITE3040 | |
| Accelerator DMP-30 | 0.8 |
| dimethylbenzene | 12.5 |
| n-butanol | 10 |

### Embodiment 5

### Preparation of Component A:

(1) The preparation of double-layer coated hollow glass microspheres is the same as Embodiment 3;
(2) Component A was prepared by high-speed dispersion of bisphenol A epoxy resin 618, double-layer coated hollow glass microspheres, talcum powder, barium sulfate, iron oxide red, polyamide wax powder OPTIMA, wetting dispersant BYK-9076, defoamer BYK-085, silane coupling agent A187, xylene, n-butanol, and non floating aluminum powder slurry 2501 according to the ratio in Table 5.

### Preparation of Component B:

Adding the phenolic amide curing agent LITE3005, accelerator DMP-30, xylene, and n-butanol into the paint tank according to the ratio in Table 5, and stirring at high speed for 30 minutes using a high-speed shearing and dispersing device to obtain component B.

The weight ratio of the component A to the component B is 100:44.

TABLE 5

| | parts by weight |
|---|---|
| Component A | |
| Bisphenol A epoxy resin 618 | 100 |
| double-layer coated hollow | 232.6 |
| glass | |
| microspheres | |
| barium sulfate | 120 |
| talcum powder | 130.5 |
| wetting dispersant BYK-9076 | 1.2 |
| Iron oxide red | 5 |
| polyamide wax powder OPTIMA | 8.1 |
| Non-floating aluminum powder | 50.3 |
| paste 2501 | |
| Silane Coupling Agent A187 | 4.2 |
| Defoamer BYK-085 | 2.1 |
| dimethylbenzene | 87.4 |
| n-butanol | 12.8 |
| component B | |
| phenolic amide curing agent | 100 |
| LITE3005 | |
| Accelerator DMP-30 | 0.5 |
| dimethylbenzene | 9.5 |
| n-butanol | 5.3 |

### Comparative Example 1

Compared to Embodiment 1, Comparative Example 1 did not use double-layer coated hollow glass microspheres and was replaced with an equal amount of epoxy resin 601. The specific preparation method is as follows:

### Preparation of Component A:

Component A was prepared by high-speed dispersion of bisphenol A epoxy resin 618, bisphenol A epoxy resin 601, barium sulfate, talcum powder, carbon black, titanium dioxide, polyamide wax powder ultra, wetting dispersant BYK-359, defoamer BYK-530, silane coupling agent KH560, xylene, n-butanol, and non floating aluminum powder slurry 2501 according to the ratio in Table 6.

### Preparation of Component B:

Adding phenolic amide curing agent LITE3040, accelerator DMP-30, xylene, and n-butanol to the paint tank according to the ratio in Table 6, and stirring at high speed for 30 minutes using a high-speed shearing and dispersing device to obtain component B.

The weight ratio of the component A to the component B is 100:17.3.

TABLE 6

| | parts by weight |
|---|---|
| Component A | |
| Bisphenol A epoxy resin 618 | 100 |
| Bisphenol A epoxy resin 601 | 207.9 |
| barium sulfate | 110 |
| talcum powder | 140 |
| Titanium Dioxide | 2.7 |
| carbon black | 0.31 |
| Non-floating aluminum powder | 40 |
| paste 2501 | |
| Polyamide Wax powder Ultra | 6.8 |
| Silane Coupling Agent KH560 | 4.2 |
| wetting dispersant BYK-359 | 3 |
| Defoamer BYK530 | 3.96 |
| dimethylbenzene | 84.6 |
| n-butanol | 16.4 |
| Component B | |
| phenolic amide curing agent | 100 |
| LITE3040 | |
| Accelerator DMP-30 | 2 |
| dimethylbenzene | 5 |
| n-butanol | 5 |

### Sample Preparation:

### 1. Substrate Processing:

Thoroughly removing grease with appropriate cleaning agents, and cleaning with (high-pressure) fresh water to remove salt and other pollutants. Sandblasting to Sa2.5 level (IS08501-1:2007), surface roughness equivalent to Rugotest No. 3 N9a to N10, Keane-Tator comparison plate 2.0 (sandblasting/shot blasting), or ISO comparison plate fine medium roughness (sandblasting); Alternatively, spraying with water to Wa2-Wa2.5 level (atmospheric exposure)/minimum Wa2.5 level (immersion) (ISO8501-1:2007). Before construction, classifying flash rust according to the standard ISO 8501-4:2006.

The visible appearance of flash rust on the surface of steel after water spraying. Refer to standard GB/T8923.4-2013 (same as ISO 8501-4:2006). According to the degree of flash rust, flash rust is divided into three grades: L, M, and H.

### 2. Preparation of Paint Film:

Mixing component A and component B according to the weight ratio recited in Embodiments 1-5 and Comparative Example 1, and stirring thoroughly until uniform. Testing the density of the coating in a paint spray booth under constant temperature and humidity, and using a high-pressure airless sprayer to spray the paint film. The preparation requirements (including thickness, etc.) of the paint film should be in accordance with the corresponding testing standards, and the relevant properties of the paint film should be tested.

### (1) The Density Test Data is Shown in Table 7 Below:

TABLE 7

| | density/(g/cm³) | | | | | | |
|---|---|---|---|---|---|---|---|
| serial | Embodiment | Embodiment | Embodiment | Embodiment | Embodiment | Comparative | Test |
| number | 1 | 2 | 3 | 4 | 5 | Example 1 | Standard |
| 1 | 1.1966 | 1.1876 | 1.2011 | 1.1895 | 1.1731 | 1.3878 | GB/T6750 |

### (2) The Test Data for Salt Spray Resistance (5000 h) are Shown in Table 8 Below:

TABLE 8

| | Substrate | | | | | | | | |
|---|---|---|---|---|---|---|---|---|---|
| serial | processing | | Embodiment | Embodiment | Embodiment | Embodiment | Embodiment | Comparative | Test |
| number | method | | 1 | 2 | 3 | 4 | 5 | Example 1 | Standard |
| 1 | hand | | No bubble, | No bubble, | No bubble, | No bubble, | No bubble, | No bubble, | GB/T1771 |
| | polishing | | peeling | peeling | peeling | peeling | peeling | peeling | |
| | | | off, or | off, or | off, or | off, or | off, or | off, or | |
| | | | rusting of | rusting of | rusting of | rusting of | rusting of | rusting of | |
| | | | paint film | paint film | paint film | paint film | paint film | paint film | |
| 2 | Sandblasting | | No bubble, | No bubble, | No bubble, | No bubble, | No bubble, | No bubble, | |
| | to Sa2.5 | | peeling | peeling | peeling | peeling | peeling | peeling | |
| | | | off, or | off, or | off, or | off, or | off, or | off, or | |
| | | | rusting of | rusting of | rusting of | rusting of | rusting of | rusting of | |
| | | | paint film | paint film | paint film | paint film | paint film | paint film | |
| 3 | Water | L | No bubble, | No bubble, | No bubble, | No bubble, | No bubble, | No bubble, | |
| | sandblasting/ | | peeling | peeling | peeling | peeling | peeling | peeling | |
| | flash rust | | off, or | off, or | off, or | off, or | off, or | off, or | |
| | grade | | rusting of | rusting of | rusting of | rusting of | rusting of | rusting of | |
| | | | paint film | paint film | paint film | paint film | paint film | paint film | |
| 4 | | M | No bubble, | No bubble, | No bubble, | No bubble, | No bubble, | bubble, | |
| | | | peeling | peeling | peeling | peeling | peeling | peeling | |
| | | | off, or | off, or | off, or | off, or | off, or | off, or | |
| | | | rusting of | rusting of | rusting of | rusting of | rusting of | rusting of | |
| | | | paint film | paint film | paint film | paint film | paint film | paint film | |
| 5 | | H | No bubble, | No bubble, | No bubble, | No bubble, | No bubble, | bubble, | |
| | | | peeling | peeling | peeling | peeling | peeling | peeling | |
| | | | off, or | off, or | off, or | off, or | off, or | off, or | |
| | | | rusting of | rusting of | rusting of | rusting of | rusting of | rusting of | |
| | | | paint film | paint film | paint film | paint film | paint film | paint film | |

### (3) the Test Data for Cathodic Stripping Resistance (6 Months) are Shown in Table 9 Below:

TABLE 9

| | the distance of stripping area not be greater than the artificial opening hole/mm | | | | | | | | |
|---|---|---|---|---|---|---|---|---|---|
| | Substrate | | | | | | | | |
| serial | processing | | Embodiment | Embodiment | Embodiment | Embodiment | Embodiment | Comparative | Test |
| number | method | | 1 | 2 | 3 | 4 | 5 | Example 1 | Standard |
| 1 | hand polishing | | 7 | 7.2 | 7.3 | 7.2 | 7.8 | 7.5 | GB/T7790 |
| 2 | Sandblasting to | | 7.3 | 7.3 | 6.8 | 7.7 | 6.5 | 7.6 | GB/T7790 |
| | Sa2.5 | | | | | | | | |
| 3 | Water | L | 6.9 | 7.6 | 7.5 | 6.5 | 7.2 | 7.8 | GB/T7790 |
| 4 | sandblasting/ | M | 7.2 | 7.6 | 6.9 | 6.2 | 5.8 | 14 | GB/T7790 |
| 5 | flash rust | H | 5.8 | 6.8 | 7.9 | 7.6 | 7.4 | 19 | GB/T7790 |
| | grade | | | | | | | | |

### (4) the Test Data for Adhesion is Shown in Table 10 Below:

TABLE 10

| | Adhesion/MPa | | | | | | | | |
|---|---|---|---|---|---|---|---|---|---|
| | Substrate | | | | | | | | |
| serial | processing | | Embodiment | Embodiment | Embodiment | Embodiment | Embodiment | Comparative | Test |
| number | method | | 1 | 2 | 3 | 4 | 5 | Example 1 | Standard |
| 1 | hand polishing | | 6.2 | 6.2 | 7.3 | 6.2 | 6.8 | 6.5 | GB/T5210 |
| 2 | Sandblasting to | | 8.8 | 9.6 | 6.8 | 7.7 | 8.5 | 7.6 | |
| | Sa2.5 | | | | | | | | |
| 3 | Water | L | 7.9 | 8.6 | 7.5 | 8.5 | 8.2 | 7.8 | |
| 4 | sandblasting/ | M | 7.2 | 7.6 | 6.9 | 7.2 | 7.8 | 4.6 | |
| 5 | flash rust | H | 6.8 | 6.7 | 7.9 | 7.6 | 7.4 | 3.5 | |
| | grade | | | | | | | | |

From the test data of Embodiments 1-5 and Comparative Example 1, it can be seen that the introduction of double-layer coated hollow glass microspheres can significantly reduce the density of the coating. The density of the epoxy primer prepared by the present disclosure is 84.5% to 86.5% of that of Comparative Example 1. The introduction of isocyanate and dimer acid structured isocyanate prepolymers and modified glass microspheres into the epoxy resin molecules of the double-layer coated hollow glass microspheres in the embodiments of the present disclosure improves the medium resistance of the coating, especially on the surface of M-grade and H-grade steel structures subjected to water sandblasting, resulting in significantly improved salt spray resistance and cathodic stripping performance. The paint film with salt spray resistance above 5000 h does not bubble, fall off or rust; After 6 months of cathodic stripping, the distance at the artificial opening of the stripping area was obviously reduced, from 19 mm in Comparative Example 1 to less than 8 mm; The adhesion was obviously improved, from 3.5 MPa in Comparative Example 1 to more than 6 MPa.

The epoxy primer prepared in Embodiments 1-5 of the present disclosure has a low density and effectively achieves coating lightweighting, and has excellent adhesion, salt spray resistance, and cathodic stripping resistance on surfaces treated by manual rust removal, mechanical rust removal, and water sandblasting. It has a high tolerance for flash rust on surfaces treated by water sandblasting and can be adapted to heavy flash rust surfaces.

What is claimed is:

1. A low-density anti-corrosion primer with strong adhesion to heavy flash rust surface, wherein the epoxy primer is made from raw materials comprising the following components:
a component A and a component B;
the component A comprises epoxy resin, double-layer coated hollow glass microspheres, thixotropic agent, wetting dispersant, pigment, barium sulfate, talcum powder, solvent A, defoamer, first silane coupling agent, and aluminum powder slurry;
the component B comprises curing agent, accelerator, and solvent B;
in the component A, based on 100 parts by weight of the epoxy resin:

| | | |
|---|---|---|
| the epoxy resin | 100 | parts by weight; |
| the double-layer coated hollow | 150-300 | parts by weight; |
| glass microspheres | | |
| the thixotropic agent | 5-15 | parts by weight; |
| the wetting dispersant | 0.5-5 | parts by weight; |
| the pigment | 1-10 | parts by weight; |
| the barium sulfate | 60-200 | parts by weight; |
| the talcum powder | 60-200 | parts by weight; |
| the solvent A | 60-150 | parts by weight; |
| the defoamer | 1-5 | parts by weight; |
| the first silane coupling agent | 1-10 | parts by weight; |
| the aluminum powder slurry | 40-100 | parts by weight; |

in the component B, based on 100 parts
by weight of the curing agent:

| | | |
|---|---|---|
| the curing agent | 100 | parts by weight; |
| the accelerator | 0.5-5 | parts by weight; |
| the solvent B | 10-50 | parts by weight. |

2. The epoxy primer according to claim 1, wherein:
in the component A, based on 100 parts
by weight of the epoxy resin:

| | | |
|---|---|---|
| the epoxy resin | 100 | parts by weight; |
| the double-layer coated hollow | 150-250 | parts by weight; |
| glass microspheres | | |
| the thixotropic agent | 5-13 | parts by weight; |
| the wetting dispersant | 1.8-3 | parts by weight; |
| the pigment | 3-10 | parts by weight; |
| the barium sulfate | 90-120 | parts by weight; |
| the talcum powder | 120-150 | parts by weight; |
| the solvent A | 100-150 | parts by weight; |
| the defoamer | 2-4 | parts by weight; |
| the first silane coupling agent | 3-6 | parts by weight; |
| the aluminum powder slurry | 40-80 | parts by weight; |

in component B, based on 100 parts
by weight of the curing agent:

| | | |
|---|---|---|
| the curing agent | 100 | parts by weight; |
| the accelerator | 0.5-2 | parts by weight; |
| the solvent B | 10-30 | parts by weight; |

the weight ratio of the component A to
the component B is 100:(10-50).

3. The epoxy primer according to claim 1, wherein:
the double-layer coated hollow glass microspheres are prepared by mixing and reacting raw materials including epoxy resin to be modified, rust capturing filler, isocyanate prepolymer, catalyst, and reaction solvent in a protective gas atmosphere.

4. The epoxy primer according to claim 3, wherein:
a weight ratio of the epoxy resin to be modified, the rust capturing filler, and the isocyanate prepolymer is (5-15):(1-5):1;
a dosage of the catalyst is 0.01 wt % to 5 wt % of isocyanate prepolymer;
a dosage of the reaction solvent used is 20-40 wt % of the epoxy resin to be modified;
a reaction temperature for mixed reaction is a range of 80° C. to 100° C., with a preferred range of 80° C. to 90° C., a reaction time is a range of 1 to 5 hours, with a preferred range of 2 to 3 hours.

5. The epoxy primer according to claim 3, wherein:
the rust capturing filler is prepared by immersing hollow glass microspheres in a solution containing tannic acid, a second silane coupling agent, and a soaking solvent, followed by low-temperature freeze-drying;
the isocyanate prepolymer is prepared by vacuum dehydration of dimer acid polyester polyol, followed by cooling, and then performing pre-polymerization reaction with isocyanate in a protective gas atmosphere;
the epoxy resin to be modified is at least one type of bisphenol A epoxy resins, wherein an epoxy equivalent of the epoxy resin to be modified is 150-1000;
the catalyst is at least one selected from the group consisting of sulfuric acid, perchloric acid, sodium methoxide, lithium methoxide, potassium eicosyl sulfonate, alkali metal hydroxide, triarylphosphine, triphenylphosphine, stannous octoate, dibutyltin dilaurate, and iron bromide;
the reaction solvent is a mixture of xylene and at least one of butyl acetate, propylene glycol methyl ether acetate, and dipropylene glycol dimethyl ether, wherein the weight ratio of the mixture of the xylene and at least one of the butyl acetate, the propylene glycol methyl ether acetate, and the dipropylene glycol dimethyl ether is (1.5-1):1.

6. The epoxy primer according to claim 5, wherein:
a weight ratio of the tannic acid, the second silane coupling agent, and the hollow glass microspheres is (0.1-0.5):(0.1-0.5):1;
a weight ratio of the soaking solvent, the tannic acid, the second silane coupling agent, and the hollow glass microspheres is (0.4-2):(0.1-0.5):(0.1-0.5):1;
a weight ratio of isocyanate to dimer acid polyester polyol is 1:(0.5-10).

7. The epoxy primer according to claim 5, wherein:
a standard median particle size of the hollow glass microspheres is 18-60 μm;
the second silane coupling agent is at least one selected from the group consisting of vinyltrimethoxysilane, γ-glycidoxypropyltrimethoxysilane, and γ-aminopropyltriethoxysilane;
the soaking solvent is a mixture of water and ethanol, with a weight ratio of (0.5-2):1;
the isocyanate is at least one selected from the group consisting of 2,6-toluene diisocyanate, 4,4′-diphenylmethane diisocyanate, carbodiimide-uretonimine modified 4,4′-diphenylmethane diisocyanate, 2,4′-diphenylmethane diisocyanate, and polymethylene polyphenyl polyisocyanate;
the molecular weight of the dimer acid polyester polyol is between 1000 and 10000.

8. The epoxy primer according to claim 5, wherein:
the soaking temperature is 10-50° C., and the soaking time is 1-4 hours;
the temperature of the low-temperature freeze-drying is −30° C. to −90° C., and the time of the low-temperature freeze-drying is 1-5 hours;
the temperature of the vacuum dehydration is 110-150° C., the vacuum degree is −0.08 Pa to −0.10 Pa, and the time of the vacuum dehydration is 0.5 h-2 h;
the temperature after cooling is below 60° C.;
the reaction temperature of the pre-polymerization reaction is between 80° C. and 100° C., and the reaction time of the pre-polymerization reaction is between 1 and 4 hours.

9. The epoxy primer according to claim 1, wherein:
the epoxy resin is at least one type of liquid bisphenol A epoxy resin;
the thixotropic agent is at least one selected from the group consisting of organic bentonite, modified hydrogenated castor oil, polyamide wax powder, and gas-phase silica;
the wetting dispersant is at least one selected from the group consisting of polyacrylate solution, block copolymer containing basic pigment-affinity groups, alkylammonium salt type wetting dispersant of high molecular weight copolymer, acrylic dispersing agent, organic silicon surfactant, copolymer solution with acid groups, and polycarboxylic acid alkylammonium salt solution;
the pigment is at least one selected from the group consisting of carbon black, iron oxide red, iron oxide yellow, titanium dioxide, and phthalocyanine blue;
the solvent A is a mixture of n-butanol and xylene, and the weight ratio of n-butanol to xylene is (0.1-1):1;
the first silane coupling agent is at least one selected from the group consisting of vinyltrimethoxysilane, γ-glycidoxypropyltrimethoxysilane, and γ-aminopropyltriethoxysilane;
the aluminum powder slurry is a non floating aluminum powder slurry;
the curing agent is at least one type of phenolic amide curing agent;
the accelerator is an epoxy curing accelerator at least one selected from the group consisting of triethylenediamine, 2,4,6-tris (dimethylaminomethyl) phenol, and benzyldimethylamine;
the solvent B is a mixture of n-butanol and xylene, and the weight ratio of n-butanol to xylene is (0.3-1.5): 1.

10. A preparation method for the epoxy primer according to claim 1, wherein a preparation method of the component A comprises:
preparation of rust capturing filler: taking the second silane coupling agent and tannic acid to perform surface modification on hollow glass microspheres, then soaking the hollow glass microspheres in the solution containing the second silane coupling agent, tannic acid, and soaking solvent at 10-50° C. for 1-4 hours, then freezing dry to remove water and ethanol to obtain the rust capturing filler;
synthesis of isocyanate prepolymer: performing vacuum dehydration on the dimer acid polyester polyol at 110-150° C., then adding the dehydrated dimer acid polyester polyol and isocyanate to a reaction vessel under a protective gas atmosphere (nitrogen), maintaining the reaction temperature at 80-100° C. for 1-4 hours, then measuring the content of isocyanate, and then discharging the synthesized isocyanate prepolymer;
taking another reaction vessel, performing vacuum dehydration on the epoxy resin to be modified, adding a catalyst while stirring, then gradually adding the synthesized isocyanate prepolymer, gradually heating up to 80-100° C. for reaction, then adding the synthesized rust capturing filler, adding the reaction solvent and stirring evenly, heating up to 80-100° C. for reaction, then measuring the epoxy value, cooling down to room temperature, and discharging the epoxy resin;
selecting a paint mixing tank, then adding epoxy resin, double-layer coated hollow glass microspheres, and thixotropic agent, then dispersing at high speed for 5-10 minutes to thoroughly disperse the thixotropic agent, and then adding wetting dispersant at low speed and stirring evenly;
adding 80% solvent A, pigment, talcum powder, and barium sulfate in sequence under low-speed dispersion, then stirring at high speed for 30-50 minutes to 50-70° C., dispersing to a fineness of ≤80 μm, then adding the remaining solvent A, defoamer, first silane coupling agent, and aluminum powder slurry, stirring evenly, and then discharging the epoxy primer.
